(19) United States
(12) Patent Application Publication
(10) Pub. No.: US 2026/0159684 A1
(43) Pub. Date: Jun. 11, 2026

(54) CURABLE COMPOSITION AND CURED COMPOSITIONS DERIVED THEREFROM

(71) Applicant: ROGERS CORPORATION, Chandler, AZ (US)

(72) Inventors: William Scholz, Scottsdale, AZ (US); Wayne Wilson, Mesa, AZ (US)

(21) Appl. No.: 19/180,777

(22) Filed: Apr. 16, 2025

Related U.S. Application Data
(60) Provisional application No. 63/635,132, filed on Apr. 17, 2024.

(51) Int. Cl. C08L 53/02; C08K 7/26

(52) U.S. Cl. CPC C08L 53/025; C08K 7/26; C08L 2201/02; C08L 2205/03; C08L 2312/00

(57) ABSTRACT

A curable composition includes particular amounts of a hydrogenated block copolymer having terminal reactive groups, a polymeric reactive diluent having a glass transition temperature of greater than or equal to 100° C. and at least one crosslinkable reactive group, and a filler. The curable compositions can provide corresponding cured compositions which can be useful in applications including build-up films, polytetrafluoroethylene (PTFE) replacement materials, and filled laminate core materials.

### CROSS-REFERENCE TO RELATED APPLICATION

This application claims priority to U.S. Provisional Patent Application No. 63/635,132, filed on Apr. 17, 2024, the contents of which are hereby incorporated by reference in their entirety.

### BACKGROUND

This disclosure is directed to curable compositions, cured compositions derived therefrom, and use of the cured compositions in various applications.

Curable compositions are useful for a variety of applications. It would be especially desirable to provide curable compositions which exhibit good film formation and high cohesive strength, long shelf-life with storage at room temperature, excellent fill and flow characteristics at low lamination temperatures, best in class electrical loss, low permittivity (e.g., Dk 3.0), a low coefficient of thermal expansion (CTE), and strong bonding to electroless and electroplated copper conductors and copper foils. Such compositions may be particularly useful in applications including, for example, resin coated copper, bondply, copper clad laminates, and build-up films.

There remains a continuing need in the art for compositions which can provide a combination of the above-mentioned properties.

### SUMMARY

A curable composition comprises: 1 to 25 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; 0.1 to 20 weight percent of a polymeric reactive diluent having a glass transition temperature of greater than or equal to 100° C. and at least one crosslinkable reactive group; and 50 to 90 weight percent of a filler; wherein weight percent of each component is based on a total weight of dry components of the curable composition.

A varnish comprises the curable composition.

A cured composition can be obtained from the curable composition.

A composite laminate comprises the cured composition.

The above described and other features are exemplified by the following detailed description.

### DETAILED DESCRIPTION

The present inventors have identified particular curable compositions that can be tailored to provide a desirable combination of properties including good dielectric properties, good copper peel strength, good coefficient of thermal expansion, and in some instances, improved flame-retardant properties. The curable compositions can advantageously be cured to form products suitable for a variety of applications, including as build up films, polytetrafluoroethylene (PTFE) replacement products, and for use in copper clad laminates. A significant improvement is therefore provided by the present disclosure.

Accordingly, an aspect of the present disclosure is a curable composition. The curable composition comprises a hydrogenated block copolymer, a polymeric reactive diluent having a glass transition temperature of greater than or equal to 100° C. and at least one crosslinkable reactive group, and a filler.

The hydrogenated block copolymer comprises at least one A block and at least one B block. For example, the hydrogenated block copolymer can be of the structure A-B, A-B-A, (A-B)ₙX, A-B-A-B, (B-A-B)ₙX, (B-A)ₙX, and (A-B-A)ₙX, wherein X is a coupling agent residue and n is 1 to 30. In the hydrogenated block copolymer, prior to hydrogenation, each A block is a rigid block derived from a first vinyl aromatic compound, and each B block is a copolymer derived from (a) a second vinyl aromatic compound (e.g., a styrenic compound), (b) a conjugated diene, and optionally (c) a third vinyl aromatic compound. The second and third vinyl aromatic compounds can be the same or different.

In an aspect, the first vinyl aromatic compound can be any aromatic compound having at least one vinyl group attached thereto. Exemplary classes of compounds can include substituted and unsubstituted styrenes, substituted and unsubstituted vinyl naphthalenes, vinyl indenes, vinyl anthracenes, 1,1-diphenyl ethylene, and combinations thereof. Specific examples can include C₈₋₂₀ vinyl aromatic compounds, such as o-methylstyrene, p-methylstyrene, p-tert-butylstyrene, 2,4-dimethylstyrene, alpha-methylstyrene, vinylnaphthalene, vinyltoluene and vinylxylene, or combinations thereof. In an aspect, the first vinyl aromatic compound can be para-methylstyrene.

In an aspect, the second vinyl aromatic compound can be a styrenic compound, for example, a styrenic compound according to Formula (I), a vinyl benzocyclobutene according to Formula (II), a vinyl dihydroindene of Formula (III), a vinyl tetrahydronaphthalene of Formula (IV), or a combination thereof.

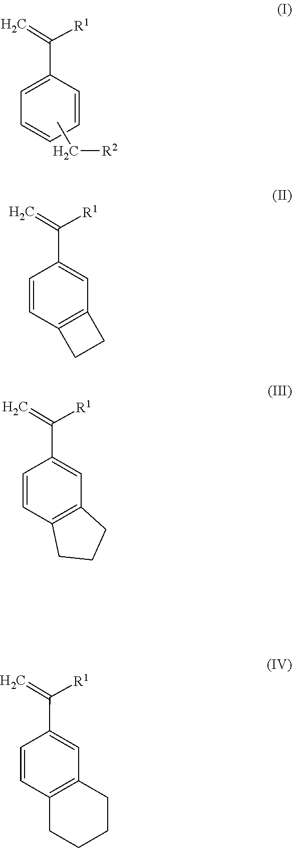

In the foregoing Formulas, R¹ is hydrogen or methyl and R² is hydrogen or a monovalent alkyl group. In an aspect, the monomer (a) of the B block is selected from o-methylstyrene, p-methylstyrene, o-ethyl styrene, p-ethyl styrene, o-isopropylstyrene, para-isopropylstyrene, o-methyl-a-methylstyrene, p-methyl-a-methylstyrene, o-ethyl-a-methylstyrene, p-ethyl-a-methylstyrene, o-isopropyl-a-methylstyrene, para-isopropyl-a-methylstyrene and mixtures thereof.

In an aspect, the conjugated diene of the B block of the hydrogenated block copolymer can comprise butadiene, isoprene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and combinations thereof. When present, the third vinyl aromatic compound can be any aromatic compound having at least one vinyl group attached thereto, and can be as described above for the first vinyl aromatic compound.

In an aspect, the A block can have a peak molecular weight (Mp) of 3 to 60 kilograms per mole (kg/mol), or 5 to 50 kg/mol, or 10 to 45 kg/mol, or 15 to 40 kg/mol, or 20 to 35 kg/mol, or greater than 10 kg/mol, or less than 50 kg/mol. In an aspect, the B block can have a Mp of 20 to 200 kg/mol, or 30 to 180 kg/mol, or 40 to 160 kg/mol, or 50 to 140 kg/mol, or 60 to 120 kg/mol, or greater than 20 kg/mol, or less than 160 kg/mol. Molecular weight in the context of the hydrogenated block copolymer refers to the styrene equivalent molecular weight, for example measured by gel permeation chromatography (GPC) relative to polystyrene standards.

In an aspect, the polymerized units of the B block derived from the monomer (a) (i.e., the second vinyl aromatic compound) constitutes from 10 to 80 weight percent, or 15 to 75 weight percent, or 20 to 70 weight percent, or 25 to 60 weight percent, or 30 to 65 weight percent, or greater than 15 weight percent, or less than 75 weight percent, each based on a total weight of the B block of the hydrogenated block copolymer. In an aspect, the polymerized units of the B block derived from the monomer (a) constitutes from 10 to 70 weight percent, or 15 to 65 weight percent, or 20 to 60 weight percent, or 25 to 55 weight percent, or 30 to 50 weight percent, or greater than 15 weight percent, or less than 65 weight percent, each based on a total weight of the hydrogenated block copolymer.

After hydrogenation, the hydrogenated block copolymer can have a residual olefinic unsaturation content of 0 to 1.5 milliequivalents per gram (meq/g) of olefinic C═C groups. Residual olefinic unsaturation can be measured, for example, by ozone titration or by proton nuclear magnetic resonance (1H NMR) spectroscopy. Within the above range, the residual olefinic unsaturation content can be 0.01 to 1.4 meq/g, or 0.02 to 1.3 meq/g, 0.05 to 1.2 meq/g, or 0.1 to 1.1 meq/g, or 0.2 to 1.0 meq/g, or 0.025 to 0.8 meq/g, or greater than 0 meq/g, or less than 1.0 meq/g.

In an aspect, the hydrogenated block copolymer can include 10 to 50 weight percent of polymerized units derived from para-methylstyrene or 15 to 45 weight percent, or 20 to 40 weight percent, or greater than 15 weight percent, or less than 60 weight percent, each based on the total weight of the hydrogenated block copolymer.

In an aspect, the hydrogenated block copolymer can have a corrected 1,4-diene unit content from 10 to 70 weight percent, or 15 to 65 weight percent, or 20 to 60 weight percent, or 25 to 55 weight percent, or greater than 15 weight percent, or less than 65 weight percent, each based on the total weight of the hydrogenated block copolymer. In an aspect, the B block can have a corrected 1,4-diene unit content of 10 to 60 weight percent, or 15 to 55 weight percent, or 20 to 50 weight percent, or 25 to 45 weight percent, or greater than 15 weight percent, or less than 55 weight percent, each based on the total weight of the B block. Corrected 1,4-diene content (C14DUC) as used herein refers to a polymer block having repeat units derived from butadiene (Bd), isoprene (Ip) or combinations thereof, and is mathematically given in terms of the parameters: weight percent Bd content (B_{w}) in the total dienes in the polymer block, weight percent of 1,4-addition units of Bd (B14) in the Bd units in the polymer block, weight percent Ip content (I_{w}) in the total dienes in the polymer block, and weight percent of 1,4-addition units of Ip (114) in the Ip units in the polymer block, by equation (1):

$$C 14 DUC = ( {B}_{w} * B 14 / 100 ) + {I}_{w} * ( I 14 - 40 ) / 100 \qquad ( 1 )$$

Polymerization of a conjugated diene gives rise to polymerized units that are based on addition across both double bonds (giving rise to 1,4-addition units) as well as one double bond (giving rise to side vinyl groups).

In a specific aspect, the B block is derived from para-methylstyrene and a conjugated diene selected from isoprene, butadiene, and combinations thereof. In an aspect, the hydrogenated block copolymer can optionally further comprise a C block, which can be derived from a conjugated diene, for example butadiene, isoprene, or a combination thereof. The C block can preferably be hydrogenated.

Exemplary hydrogenated block copolymers useful in the curable composition of the present disclosure, and methods for the manufacture thereof, can be as further described in U.S. Publication No. 2022/0049083, the contents of which is hereby incorporated by reference in its entirety and can include those available as MD3501 from Kraton Corporation.

The hydrogenated block copolymer can be present in the curable composition in an amount of 1 to 25 weight percent, based on a total weight of dry components of the curable composition. Within this range, the hydrogenated block copolymer can be present in an amount of at least 2 weight percent, or at least 3 weight percent, or at least 4 weight percent, or at least 5 weight percent. Also within this range the hydrogenated block copolymer can be present in an amount of at most 24 weight percent, or at most 23 weight percent, or at most 22 weight percent, or at most 21 weight percent, or at most 22 weight percent, or at most 20 weight percent. In an aspect, the hydrogenated block copolymer can be present in an amount of 5 to 20 weight percent, each based on the total weight of dry components of the curable composition.

In addition to the hydrogenated block copolymer, the curable composition further comprises a polymeric reactive diluent having a glass transition temperature of greater than or equal to 100° C. and at least one crosslinkable reactive group. The polymeric reactive diluent comprises unsaturation that is capable of participating in a crosslinking reaction (e.g., free radical crosslinking).

The Tg of the polymeric reactive diluent may be in the range of 100 to 300° C., or 110 to 300° C. The polymeric reactive diluent can have a number average molecular weight of 800 to 10,000 grams per mole (g/mol) and a weight average molecular weight of 1,000 to 500,000 grams per mole (g/mol). Within this range, the weight average molecular weight can be at least 2,000 g/mol, or at least 3,000 g/mol, or at least 5,000 g/mol, and at most 100,000, or at most 50,000 g/mol, or at most 30,000 g/mol, or at most 15,000 g/mol (for example as determined by gel permeation chromatography relative to polystyrene).

In an aspect, the polymeric reactive diluent can comprise a polymer having crosslinkable reactive groups, a Tg of 100 to 300° C., a number average molecular weight of 800 to 10,000 g/mol, and a weight average molecular weight of 1,000 to 15,000 grams per mole. Exemplary materials can include, but are not limited to, those obtained as ELPAC™ HC-G series polymers, including ELPAC™ HC-G0024 from JSR Corporation.

The polymeric reactive diluent can be included in the curable composition in an amount of 0.1 to 20 weight percent, based on the total weight of dry components of the curable composition. Within this range, the polymeric reactive diluent can be included in the curable composition in an amount of 0.2 to 18 weight percent, or 0.3 to 16 weight percent, or 0.4 to 14 weight percent, or 0.5 to 12 weight percent, or 1 to 10 weight percent, each based on the total weight of dry components of the curable composition. The curable composition can include 3.8 to 4.4 weight percent, or 3.8 to 4.2 weight percent, or 3.9 to 4.3 weight percent, or 3.1 to 4.2 weight percent, of the polymeric reactive diluent, each based on the total weight of dry components of the curable composition.

The curable composition can further include a polyaromatic vinyl compound. The polyaromatic vinyl compound can be a compound represented by formula (1).

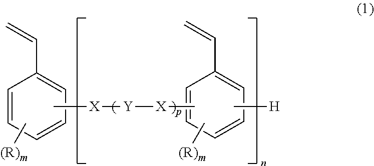

In formula (1), X and Y each represent a different optional organic group. When there are a plurality of X, the plurality of X can be the same as or different from each other. When there are a plurality of Y, the plurality of Y can be the same as or different from each other. R is a hydrocarbon group having 1 to 10 carbon atoms or a halogenated alkyl group. When there are a plurality of R, the plurality of R can be the same as or different from each other. The variable m is an integer of 0 to 3, for example, an integer of 0 to 2 or 0, n represents a repeating unit and satisfies 1≤n≤20, for example, 1.1≤n≤20, 1.1≤n≤10, or 1.1≤n≤5, and p represents a repeating unit and satisfies 0≤p≤20. The lower limit value of p is, for example, 0 or 1. The upper limit value of p is 20, for example, 10, 5, 3, or 0.

The value of n can be calculated from a value of the weight average molecular weight (Mw) of the compound determined by gel permeation chromatography (GPC) measurement. The weight average molecular weight is, for example, 200 or more and less than 5,000, 300 or more and less than 3,000, or 400 or more and less than 2,000.

R is a hydrocarbon group having 1 to 10 carbon atoms, for example, a hydrocarbon group having 1 to 5 carbon atoms or a hydrocarbon group having 1 to 3 carbon atoms. When R is a hydrocarbon group having 10 or less carbon atoms, the compound can be less likely to undergo molecular vibration when exposed to high frequencies, and the compound can have excellent electrical properties.

In formula (1), X represents, for example, any one or more of structures (A) to (D) of in formula (2), structure (A) or (C), or structure (A). Due to a nonpolar and rigid structure, the distance between crosslinking points and the aromatic ring density derived from these structures, the cured product is excellent in various properties such as electrical properties, heat resistance, low water absorption, toughness (mechanical strength), adhesion, and flame retardancy.

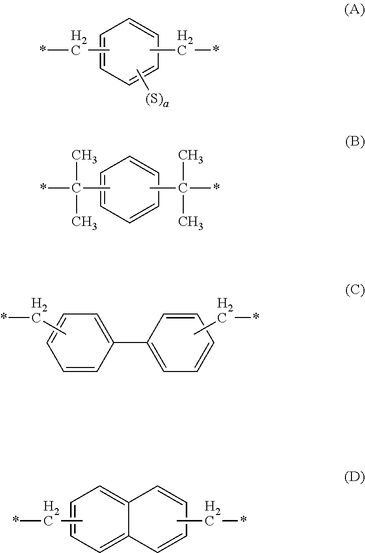

S is a hydrocarbon group having 1 to 3 carbon atoms, for example, a methyl group, and a is an integer of 0 to 4, for example 0 or 1 or 0. When there are a plurality of S, the plurality of S can be the same as or different from each other. The symbol * indicates a bonding position.

In formula (1), Y represents, for example, any one or more of structures (E) to (K) of formula (3), structure (E) or (F), or structure (E).

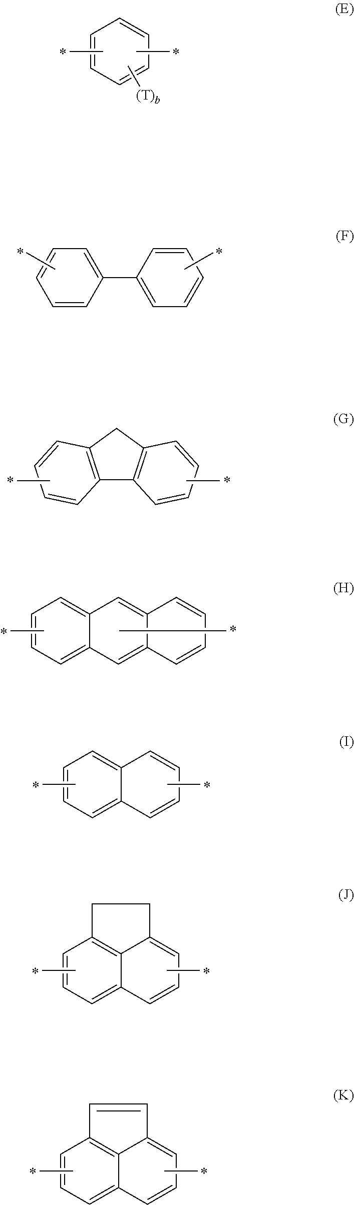

T is a hydrocarbon group having 1 to 3 carbon atoms, for example, a methyl group, and b is an integer of 0 to 4, for example, an integer of 0 to 3 or 3. When there are a plurality of T, the plurality of T can be the same as or different from each other. The symbol * indicates a bonding position.

The polyaromatic vinyl compound can be a compound represented by formula (4).

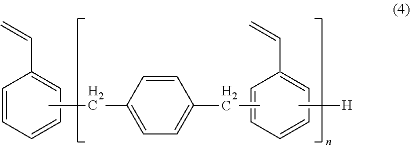

The Tg of the polyaromatic vinyl compound can be greater than 200° C., or greater than 350° C. The aromatic groups contribute to the relatively high Tg of the polyaromatic vinyl compound.

When present, the polyaromatic vinyl compound can be present in the curable composition in an amount of 0.1 to 10 weight percent, based on the total weight of dry components of the curable composition. The curable composition can include 0.5 to 2.1 weight percent, or 1 to 2.1 weight percent, of the polyaromatic vinyl compound, based on the total weight of dry components of the curable composition.

The molecular weight of the polyaromatic vinyl compound is relatively low since the polyaromatic vinyl compound is a liquid. Being a liquid at room temperature allows the curable composition some flexibility to lay-flat (i.e., no curl) when dried, which can enable handle-ability laying up the product prior to cure. The vinyl groups of the polyaromatic vinyl compound provide reactivity to the polyaromatic vinyl compound.

Inclusion and the amount of the polyaromatic vinyl compound in a curable composition can provide the curable composition same with an improved (e.g., lower) CTE. The polyaromatic vinyl compound can improve flow properties of a curable composition including same, which can be important to promote adhesion to copper foil in copper clad laminate (CCL) applications.

A weight ratio of the polymeric reactive diluent to the polyaromatic vinyl compound can be in a range of 0.11:1 to 3.25:1. Adjustment of the weight ratio of the polymeric reactive diluent to the polyaromatic vinyl compound can affect properties of a curable composition including the same, such as, flow. Adjustment of the weight ratio of the polymeric reactive diluent to the polyaromatic vinyl compound can affect properties of a dried curable composition including the same, such as, tackiness or releasability from a carrier or liner, flexibility, CTE, or a combination thereof.

The curable composition can include 14.6 to 15.7 weight percent of the hydrogenated block copolymer; 3.1 to 4.2 weight percent the polymeric reactive diluent; 1 to 2.1 weight percent of the polyaromatic vinyl compound; and 69.4 to 70.4 weight percent of a filler, wherein weight percent of each component is based on the total weight of dry components of the curable composition.

In contrast to the disclosed polyaromatic vinyl compound, a polymer that includes unsaturation in the backbone thereof may not fully react even after crosslinking, and a final product may not be stable electrically over time. For example, the Df of a composition including a polymer that includes unsaturation in the backbone thereof can increase with heat, or humidity, or a combination thereof exposure over time.

The curable composition further comprises a filler. In an aspect, the filler can be selected to adjust one or more desired properties including dielectric constant, dissipation factor, coefficient of thermal expansion, and other properties of a cured composition derived from the curable composition. Exemplary fillers can include, but are not limited to, titanium dioxide (such as rutile and anatase), barium titanate, strontium titanate, silica (for example, fused amorphous silica, microspherical silica, hollow silica, or a combination thereof), corundum, wollastonite, Ba₂Ti₉O₂₀, solid glass spheres, hollow glass spheres, hollow ceramic spheres, hollow soda-lime-borosilicate glass microspheres, quartz, boron nitride, aluminum nitride, silicon carbide, beryllia, alumina, alumina trihydrate, magnesia, mica, talc, nanoclay, magnesium hydroxide, or a combination thereof.

In a specific aspect, the filler comprises silica. The silica can comprise solid silica particles, hollow silica particles, hollow glass microspheres, or a combination thereof. In an aspect, the silica can comprise solid silica particles. In an aspect, the silica can comprise hollow silica particles. In an aspect, the silica can comprise a combination of solid silica particles and hollow silica particles, for example, hollow soda-lime-borosilicate glass microspheres. When a combination is used, the solid and hollow silicas can be present in a solid:hollow volume ratio of 100:0 to 75:25. The silica can have a D50 particle size of 0.2 to 20 micrometers, or 1 to 15 micrometers, or 1 to 10 micrometers, or 1 to 5 micrometers. The particle size can be determined using dynamic light scattering. The D50 refers to 50% by volume of the particles having a particle size below the number.

The filler can be a hollow filler including microspherical silica, hollow silica, hollow soda-lime-borosilicate glass microspheres, or a combination thereof. The hollow soda-lime-borosilicate glass microspheres can be present in an amount of 0 to 2.5 weight percent, or 0 to 2 weight percent, each based on the total weight of dry components of the curable composition. The hollow silica can be present in an amount of 0 to 4 weight percent, or 0 to 3 weight percent, each based on the total weight of dry components of the curable composition. The filler can include hollow soda-lime-borosilicate glass microspheres and a solid silica having a D50 of greater than or equal to 8 micrometers (μm).

Without wishing to be bound by any theory, it is believed that the solid silica having a D50 of greater than or equal to 8 micrometers can improve flow characteristics and bond properties. The hollow soda-lime-borosilicate glass microspheres and solid silica can help provide a desirable, e.g., lower, Dk to the cured composition including same. The Dk of the cured composition can be adjusted by adjusting the volume percent of filler and adjusting the ratio of solid to hollow filler.

Smaller solid particles can provide products with lower bow and twist. Bow and twist is a measurement of the maximum vertical displacement of a one-side fully etched 12 inch by 12 inch (30.5 centimeter by 30.5 centimeter) CCL panel from a flat surface. Bow measures the displacement from the center section of the panel and twist measures the same from the four corners of the panel. Smaller solid particles can provide better bow and twist but lower bond as compared to larger particles that can provide poorer bow and twist but better bond.

The weight percent of hollow filler used can depend on the specific gravity of the filler. A hollow filler with a low specific gravity can contribute to a high volume percent of the curable or cured composition at a lower weight percent, based on the total weight of the curable or cured composition.

Suitable silica is available from manufacturers such as Cabot Corporation, Clariant, Fuso Chemical Co. Ltd., Third Age Technology, Cabot Corporation, Fuji Silysia Chemical, Orisil, Denka Company Limited, Evonik Industries, W. R. Grace & Co., Wacker Chemie AG, Glassven C.A, Imerys S.A., AGC Chemicals, and Merck KGaA.

Hollow soda-lime-borosilicate glass microspheres can be less expensive and more readily available than solid silica, and inclusion of hollow soda-lime-borosilicate glass microspheres can provide desirable results at a lower cost as compared to using only solid silica. D50 can be measured using a laser diffraction method to measure particle size distributions, for example, using a Horiba LA-951 instrument.

The filler can be included in the curable composition in an amount of 50 to 90 weight percent, based on the total weight of dry components of the curable composition. Within this range, the filler can be present in an amount of at least 51 weight percent, or at least 52 weight percent, or at least 53 weight percent, or at least 55 weight percent, or at least 60 weight percent, each based on the total weight of dry components of the curable composition. Also within this range, the filler can be present in an amount of at most 89 weight percent, or at most 85 weight percent, each based on the total weight of dry components of the curable composition. For example, the filler can be present in an amount of 51 to 89 weight percent, or 52 to 88 weight percent, or 53 to 87 weight percent, each based on the total weight of dry components of the curable composition. In an aspect, the filler can be present in an amount of 60 to 85 weight percent, each based on the total weight of dry components of the curable composition. The curable composition can include 69.0 to 71.7 weight percent, or 69.1 to 71.7 weight percent, or 69.3 to 70.4 weight percent, or 69.4 to 70.4 weight percent, of the filler, each based on the total weight of dry components of the curable composition.

The filler can be included in the curable or cured composition in an amount of 50 to 70 volume percent, based on the total volume of the curable or cured composition. For example, the curable or cured composition can include 56 to 64 volume percent, or 58 to 61 volume percent, of the filler, each based on the total volume of the curable or cured composition.

In addition to the hydrogenated block copolymer, the polymeric reactive diluent, and the filler, the curable composition can further comprise one or more optional components. For example the curable composition can optionally further include an initiator, a flame retardant, an additive composition, a second reactive diluent, or a combination thereof.

In an aspect, the curable composition can further comprise an initiator. The initiator can decompose (e.g., thermally) to form free radicals, which then initiate polymerization of crosslinkable groups within the formulation. These initiators generally provide weak bonds, for example, bonds that have small dissociation energy. The free-radical initiator can comprise at least one of a peroxide initiator, an azo initiator, a carbon-carbon initiator, a persulfate initiator, a hydrazine initiator, a hydrazide initiator, a benzophenone initiator, or a halogen initiator. In an aspect, the initiator can comprise a peroxide initiator. For example, the initiator can comprise an organic peroxide, for example, at least one of dicumyl peroxide, 2,5-dimethyl-2,5-di(t-butylperoxy) hexane, α,α′-di(t-butylperoxy)diisopropylbenzene, 2,5-dimethyl-2,5-di(t-butylperoxy) hexyne, or 3,1,1-di(t-butylperoxy)-3,5,5-trimethylcyclohexane. Optionally, the initiator can be light sensitive comprising, for example, α-hydroxy ketone, phenylglyoxylate, benzyldimethyl-ketal, α-amino ketone, monoacyl phosphine (MAPO), bisacyl phosphine (BAPO), phosphine oxides or metallocenes. The initiator can be present in an amount of 0.01 to 5 weight percent, or 0.05 to 3 weight percent, or 0.1 to 1.5 weight percent, each based on the total weight of dry components of the curable composition. Combinations of initiators can be used.

The curable composition can optionally further comprise a flame retardant. The flame retardant can be halogenated or unhalogenated. The flame retardant can be present in the curable composition in an amount of 1 to 20 weight percent, or 2 to 19 weight percent, or 3 to 18 weight percent, or 4 to 17 weight percent, or 5 to 15 weight percent, each based on the weight of the curable composition.

In an aspect, the flame retardant can be inorganic and can be present in the form of particles. The inorganic flame retardant can comprise a metal hydrate, having, for example, a volume average particle diameter of 1 to 500 nanometers (nm), or 1 to 200 nm, or 5 to 200 nm, or 10 to 200 nm; alternatively the volume average particle diameter can be 500 nm to 15 micrometer (μm), for example, 1 to 5 μm. The metal hydrate can comprise a hydrate of a metal, for example, at least one of Mg, Ca, Al, Fe, Zn, Ba, Cu, or Ni. Hydrates of Mg, Al, or Ca can be used, for example, at least one of aluminum hydroxide, magnesium hydroxide, calcium hydroxide, iron hydroxide, zinc hydroxide, copper hydroxide, nickel hydroxide, or hydrates of calcium aluminate, gypsum dihydrate, zinc borate or barium metaborate. Composites of these hydrates can be used, for example, a hydrate containing Mg and at least one of Ca, Al, Fe, Zn, Ba, Cu, or Ni. A composite metal hydrate can have the formula MgMₓ(OH)_{y} wherein M is Ca, Al, Fe, Zn, Ba, Cu, or Ni, x is 0.1 to 10, and y is 2 to 32. The flame retardant particles can be coated or otherwise treated to improve dispersion and other properties.

Organic flame retardants can be used alternatively or in addition to the inorganic flame retardants. Examples of organic flame retardants include melamine cyanurate, fine particle size melamine polyphosphate, various other phosphorus-containing compounds such as aromatic phosphinates, diphosphinates, phosphonates, phosphates, polysilsesquioxanes, siloxanes, halogenated compounds (such as hexachloroendomethylenetetrahydrophthalic acid (HET acid), tetrabromophthalic acid, or dibromoneopentyl glycol), or dihydro-oxa-phospho-phenantrene (DOPO) derivatives (wherein by “derivative” is meant that one or more hydrogens in DOPO (CAS RN 35948-25-5) have been replaced by one or more substituents (such derivative also referred to as an “oxaphosphorinoxide-containing aromatic compound,” i.e. a compound containing at least one such DOPO radical or moiety)). A flame retardant (such as a bromine-containing flame retardant) can be present in an amount of 1 to 15 weight percent, or 5 to 15 weight percent, or 5 to 13 weight percent, each based on the total weight of dry components of the curable composition. Examples of brominated flame retardants include Saytex™ BT93W (ethylene bistetrabromophthalimide), Saytex™ 120 (tetradecabromodiphenoxy benzene), Saytex™ 102 (decabromodiphenyl oxide), and Saytex™ 8010 (ethylene-1,2-bis(pentabromophenyl). The flame retardant can be used in combination with a synergist, for example, a halogenated flame retardant can be used in combination with a synergist such as antimony trioxide, and a phosphorus-containing flame retardant can be used in combination with a nitrogen-containing compound such as melamine.

The curable composition can optionally further comprise a second reactive diluent. The second reactive diluent can provide one or more, such as one, two, three, or more functional groups capable of reacting with a curable monomer or oligomer. The second reactive diluent may include reactive groups such as a hydroxyl group, an ethylenically unsaturated group, an epoxy group, an amino group, or a combination thereof. For example, the second reactive diluent may include one or more hydroxyl groups and one or more amino groups, ethylenic unsaturation, and the like. Examples of second reactive diluents include monofunctional and polyfunctional compounds such as monomers, especially comprising vinyl, acrylic, acrylate, acrylamide, or hydroxyl groups. The second reactive diluent is typically a mono-, di-, or tri-functional monomer or oligomer having a low molecular weight. Typical examples are acrylates and methacrylate esters, including mono-, di-, and tri-(meth)acrylates and -acrylates. The second reactive diluent is different from the polymeric reactive diluent.

The curable composition can further optionally include an additive composition comprising one or more additives with the proviso that the presence of the addition composition does not significantly adversely affect a desired property of the curable composition. In an aspect, the additive composition can comprise an antioxidant, a silane, or a combination thereof.

Antioxidant additives can include, for example, organophosphites such as tris(nonyl phenyl) phosphite, tris(2,4-di-t-butylphenyl) phosphite, bis(2,4-di-t-butylphenyl) pentaerythritol diphosphate, distearyl pentaerythritol diphosphate; alkylated monophenols or polyphenols; alkylated reaction products of polyphenols with dienes, such as tetrakis[methylene (3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl) propionate, pentaerythrityl-tetrakis[3-(3,5-di-tert-butyl-4-hydroxyphenyl) propionate; amides of beta-(3,5-di-tert-butyl-4-hydroxyphenyl)-propionic acid, or a combination thereof. When present, the antioxidant can be present in the curable composition in an amount of greater than 0 to 0.3 weight percent, based on the total weight of dry components of the curable composition.

Silanes can function as coupling agents to promote the formation of or participate in covalent bonds that improve adhesion between the filler and the polymer components of the curable composition. Exemplary silane coupling agents can include vinyltrichlorosilane, vinyltrimethoxysilane, trivinylmethoxysilane, vinyltriethoxysilane, vinyltris(β-methoxyethoxy) silane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, N-β (aminoethyl) γ-aminopropylmethyldimethoxysilane, N-β (aminoethyl) γ-aminopropyltrimethoxysilane, bis(trimethoxysilylethyl)benzene, bis(triethoxysilyl)ethylene, triethoxysilyl-modified butadiene, styrylethyltrimethyloxysilane, N-β (aminoethyl) γ-aminopropyltriethoxysilane, γ-aminopropyltrimethoxysilane, γ-aminopropyltriethoxysilane, N-phenyl-γ-aminopropyltrimethoxysilane, trimethoxyphenylsilane, perfluorocotyltriethoxysilane, γ-mercaptopropyltrimethoxysilane, and octylvinyl trimethoxy silane. When present, the silane can be present in the curable composition in an amount of greater than 0 to 1.5 weight percent, based on the total weight of dry components of the curable composition.

The curable composition can optionally further comprise a polybutadiene, for example in an amount of 0.1 to 10 weight percent based on the total weight of dry components of the curable composition. Preferably, when present, the polybutadiene is a polybutadiene homopolymer and comprises at least 80 weight percent 1,2-vinyl content, wherein weight percent is based on the total weight of the polybutadiene. Exemplary polybutadiene homopolymers are available as Nisso B-1000, B-2000, or B-3000 from Nisso.

A weight ratio of the polymeric reactive diluent to the polybutadiene can be in a range of 0.11:1 to 1.1:1. Adjustment of the weight ratio of the polymeric reactive diluent to the polybutadiene can affect properties of a curable composition including the same, such as, flow. Adjustment of the weight ratio of the polymeric reactive diluent to the polybutadiene can affect properties of a dried curable composition including the same, such as, tackiness or releasability from a carrier or liner, flexibility, CTE, or a combination thereof. Thermal stability of the polybutadiene may not be as desirable as the thermal stability of the polyaromatic vinyl compound, and the ratio of polymeric reactive diluent to the polybutadiene may be narrower than a ratio of polymeric reactive diluent to polyaromatic vinyl compound.

The curable composition can include 14.9 to 15.9 weight percent of the hydrogenated block copolymer; 3.8 to 4.2 weight percent the polymeric reactive diluent; 1 to 1.1 weight percent of the polybutadiene; and 69.1 to 71.7 weight percent of a filler, wherein weight percent of each component is based on the total weight of dry components of the curable composition.

Presence of a third polymer, for example, the polybutadiene or the polyaromatic vinyl compound can improve properties of the curable composition, cured composition, or a combination thereof. The third polymer can be a liquid and can aid with a coating of the curable composition (for example, prior lamination) to lay-flat, a desirable characteristic. Lay-flat (or the absence of curl when the coating is dried but not crosslinked) and easy release from a liner are desirable for production to make a finished product.

In an aspect, each A block of the hydrogenated block copolymer is derived from para-methylstyrene; each B block of the hydrogenated block copolymer is a copolymer derived from para-methylstyrene and a conjugated diene selected from the group consisting of isoprene, butadiene, or a combination thereof, wherein the B block has a conjugated diene content of 10 to 55%; wherein each A block has a peak molecular weight of 3 to 60 kg/mol and each B block has a peak molecular weight of 20 to 200 kg/mol. In an aspect, the filler comprises silica.

The curable composition can be formed by combining the various components, in any order, optionally in the melt or in an inert solvent. The combining can be by any suitable method, such as blending, mixing, or stirring. The components used to form the curable composition can be combined by dissolving or suspending the component in a solvent to provide a coating mixture or solution.

Another aspect of the present disclosure is a varnish comprising the curable composition described herein and a solvent. The solvent can be selected so as to dissolve the components of the curable composition, disperse particulate additives and any other optional additives that can be present, and to have a convenient evaporation rate for forming, drying, and b-staging. The solvent can comprise, for example, at least one of xylene, toluene, methyl ethyl ketone (MEK), methyl isobutyl ketone (MIBK), hexane, a higher liquid linear alkane (for example, heptane, octane, or nonane), cyclohexane, cyclohexanone, isophorone, glycol ether PM, glycol ether PM acetate, or a terpene-based solvent. In an aspect, the solvent can comprise at least one of xylene, toluene, methyl ethyl ketone, methyl isobutyl ketone or hexane. In an aspect, the solvent can comprise at least one of xylene or toluene. The solvent can be present in an amount of 2 to 20 weight percent, or 2 to 10 weight percent, or 2 to 5 weight percent based on the total weight of the varnish. The varnish can comprise 80 to 98 weight percent solids (all components other than the solvent), or 15 to 40 weight percent solids, each based on the total weight of the varnish.

The curable compositions and varnishes described herein can be used for the preparation of cured compositions. In an aspect, the cured composition can be in the form of a film, for example having a thickness of 10 to 100 micrometers.

The cured composition can be used without a reinforcing layer. For example, the cured composition can be used without a glass supporting structure.

The cured composition can also be a composite laminate wherein the cured composition is in contact with a reinforcing layer. The reinforcing layer can comprise a fabric, for example a fibrous layer comprising a plurality of thermally stable fibers. The fabric can be woven or non-woven. The fabric can reduce shrinkage of the composite upon cure within the plane of the composite. In addition, the use of the fabric can help render the composite with a relatively high dimensional stability and mechanical strength (modulus). Such materials can be more readily processed by methods in commercial use, for example, lamination, including roll-to-roll lamination. The thermally stable fibers can comprise glass fibers such as at least one of E glass fibers, S glass fibers, D glass fibers, or lower dielectric constant, lower dissipation loss fibers such as L glass fibers or quartz fibers. For example, lower dielectric constant, lower dissipation factor, thermally stable fibers such as NITTOBO NE or NER commercially available from Nitto Boseki Co., Ltd. Of Tokyo, Japan or L-Glass™ fiber or L2-Glass™ fiber, each commercially available from AGY, Aiken, South Carolina are contemplated for the present disclosure. TD glass fibers and TDA glass fibers are also contemplated for the present disclosure. Thermally stable fabrics comprising glass fibers can be plain weave or spread-weave and can be balanced. Spread-weaves can enhance impedance control, resistance to conductive anodic filament (CAF) growth, dimensional stability, prepreg yields and can be more amenable to laser drilling during circuit fabrication. The fabric can comprise a lower dielectric constant, lower dissipation factor spread-weave fabric in an amount of 5 to 40 weight percent, or 15 to 25 weight percent based on the total weight of the composite. When a reinforcing layer, for example, including glass fibers, is present, the amount of filler in the curable composition disclosed herein can be reduced.

The method for treating the reinforcing layer with the curable composition is not limited and can be performed, for example, by dip coating or roll coating, optionally at an increased temperature. A single ply composite can have a thickness of 10 to 200 micrometers, or 30 to 150 micrometers. Two or more plies can be laminated together to form a multilayer composite material.

Lamination and optional curing can be by a one-step process, for example, using a vacuum press, or can be by a multi-step process. In a one-step process, the layered structure can be placed in a press, brought to a laminating pressure and heated to a laminating temperature. The laminating temperature can be 100 to 390 degrees Celsius (° C.), or 100 to 250° C., or 100 to 200° C., or 100 to 175° C., or 150 to 170° C. The laminating pressure can be 1 to 3 megapascal (MPa), or 1 to 2 MPa, or 1 to 1.5 MPa. The laminating temperature and pressure can be maintained for a desired dwell (soak) time, for example, 5 to 150 minutes, or 5 to 100 minutes, or 10 to 50 minutes, and thereafter cooled, at a controlled cooling rate (with or without applied pressure), for example, to less than or equal to 150° C.

The cured composition can exhibit one or more desirable properties. For example, the cured composition can exhibit a dissipation factor (Df) of 0.0006 to 0.005, or 0.0008 to 0.005, or 0.001 to 0.005, or 0.001 to 0.003, or 0.001 to 0.0025, or 0.001 to 0.002, or 0.0006 to 0.002, at 10 gigahertz (GHz). The cured composition can exhibit a dielectric constant (Dk) of 2.9 to 3.4 at 10 GHz. The cured composition can exhibit a coefficient of thermal expansion of less than or equal to 130 parts per million per degrees Celsius (ppm/° C.), or 5 to 130 ppm/° C., or 5 to 55 ppm/° C., or 5 to 25 ppm/° C., measured with thermomechanical analysis (TMA) over a temperature range of −55 to 288° C.

The cured composition can have a peel strength from copper of 0.5 to 5.5 pounds per linear inch (pli) (88 to 963 newtons per meter (N/m)), or 1 to 5 pli (175 to 876 N/m). The cured composition can exhibit a UL94 V0 rating at a thickness of 30 to 1,520 micrometers (1.2 to 60 mil) determined in accordance with the Underwriter's Laboratory UL 94 Standard For Safety “Tests for Flammability of Plastic Materials for Parts in Devices and Appliances.”

A prepreg, a build-up material, a bondply, a resin-coated electrically conductive layer, or a cover film can comprise the composite. The composite can be a non-clad or declad dielectric layer, a single clad dielectric layer, or a double clad dielectric layer. A double clad laminate has two electrically conductive layers, one on each side of the composite. A circuit material can comprise the composite. The circuit material is a type of circuit subassembly that has an electrically conductive layer, for example, copper, fixedly attached to a composite. Patterning the electrically conductive layer, for example by printing and etching, can provide the circuit. A multilayer circuit can comprise a plurality of electrically conductive layers, at least one of which contains an electrically conductive wiring pattern. Typically, multilayer circuits are formed by laminating two or more materials in proper alignment together, at least one of which contains a circuit layer, using bond plies, while applying heat or pressure.

This disclosure is further illustrated by the following examples, which are non-limiting.

### Examples

Materials used in the following Examples are provided in Table 1.

TABLE 1

| Component | Chemical Description | Supplier |
|---|---|---|
| SBC | Hydrogenated styrenic block copolymer having a styrene content of 45-55% | Kraton |
| | and a weight average molecular weight of 110,000-130,000 grams per mole, | |
| | obtained as MD3501 | |
| HTP | Polymer having crosslinkable reactive groups, obtained as ELPAC HC- | JSR |
| | G0024 | |
| CC | Crosslinkable polyaromatic vinyl compound, obtained as STR-2000-60ST | Nippon |
| | | Kayaku |
| PBD-1 | Polybutadiene homopolymer having a number average molecular weight of | Nisso |
| | 1,200 grams per mole and a 1,2-vinyl content of at least 85%, obtained as | |
| | Nisso B-1000 | |
| PBD-2 | Polybutadiene homopolymer having a number average molecular weight of | Nisso |
| | 2,100 grams per mole and a 1,2-vinyl content of at least 90%, obtained as | |
| | Nisso B-2000 | |
| PBD-3 | Polybutadiene homopolymer having a number average molecular weight of | Nisso |
| | 3,200 grams per mole and a 1,2-vinyl content of at least 90%, obtained as | |
| | Nisso B-3000 | |
| Silica-1 | Solid silica having a D50 of 3 micrometers | |
| Silica-2 | Hollow silica having a D50 of 2 micrometers | |
| Silica-3 | Surface treated silica having a D50 of 2.5 μm and a D100 of 10 μm, and a | |
| | specific surface area of 1.5 m²/g; and surface treated to have a vinyl | |
| | functionality | |
| Filler | Hollow soda-lime-borosilicate glass microspheres; D50 of about 25 μm, | 3M |
| | obtained as Glass Bubbles S32HS | |
| FR-1 | Ethylene-1,2-bis(pentabromophenyl), obtained as SAYTEX 8010 flame | Ablemarle |
| | retardant | |
| Peroxide-1 | Dicumyl peroxide obtained as Varox DCP-R | Vanderbilt |
| | | Chemicals |
| Initiator | Peroxide, obtained as VulCup | |
| Silane-1 | 7-Octenyltrimethoxysilane, obtained as KBM 1083 | Shin-Etsu |
| Antioxidant-1 | Oligomeric hindered amine stabilizer obtained as CHIMASSORB 944 LD | BASF |

Curable compositions for the following examples were prepared according to the following general procedure. Polymeric components were blended in a toluene solution. Crosslinker, filler, and other additives were then blended under shear with the polymeric components to provide a varnish.

Varnishes including the curable compositions were cast onto a polymeric carrier and laminated to a copper foil (HVLP3 roughness rating, 0.09 μm average roughness (Sa), and 1.31 μm peak to valley height (Sz), measured using a laser microscope) using a press cycle with a ramp rate of 7° F. per minute to a maximum temperature of 400° F. at 400 pounds per square inch (psi) (2.8 megapascals (MPa)).

Properties of the resulting films were characterized according to the following test methods. Melt rheology of the cast film (no foil) was characterized using an ATD3000 oscillating parallel plate rheometer (Alpha Technologies). Dielectric constant (Dk) and dissipation factor (Df) were measured at 10 GHz using a split post dielectric resonator. Copper adhesion was tested according to IPC TM-650 2.4.8.1. Glass transition temperature (Tg) and modulus were characterized by dynamic mechanical analysis (DMA) in tensile mode according to IPC TM-650 2.4.24.4 method.

Compositions and properties are shown in Table 2a, Table 2b, Table 2c, and Table 2d. In Table 2c and Table 2d, split post dielectric resonator (SPDR) and is a method to measure electrical properties in the XY plane and Stripline is a method to measure electrical properties in the Z plane, in accordance with Institute for Interconnecting and Packaging Electronic Circuits (IPC)-Test Method (TM)-650, Method 2.5.5.5. In Table 2c, specific gravity was measured using a cured sample from the viscosity measurement.

TABLE 2a

| | Units | E1 | E2 | E3 | E4 | E5 | E6 |
|---|---|---|---|---|---|---|---|
| Component | | | | | | | |
| SBC | dry wt % | 13.0 | 13.9 | 14.8 | 12.9 | 12.9 | 12.9 |
| HTP | dry wt % | 5.6 | 4.6 | 3.7 | 3.7 | 4.6 | 3.7 |
| PBD-2 | dry wt % | | | | | 0.9 | 1.8 |
| PBD-3 | dry wt % | | | | 1.8 | | |
| Silica-1 | dry wt % | 73.8 | 73.7 | 73.7 | 73.8 | 73.8 | 73.8 |
| Silica-2 | dry wt % | 0.4 | 0.4 | 0.4 | 0.4 | 0.4 | 0.4 |
| Silane-1 | dry wt % | 0.5 | 0.5 | 0.5 | 0.5 | 0.5 | 0.5 |
| FR-1 | phr¹ | 35 | 35 | 35 | 35 | 35 | 35 |
| Peroxide-1 | phr¹ | 1 | 1 | 1 | 1 | 1 | 1 |
| Antioxidant-1 | phr¹ | 1 | 1 | 1 | 1 | 1 | 1 |
| Properties | | | | | | | |
| Laminate thickness | inches | 0.0147 | 0.0152 | 0.0138 | 0.0135 | 0.0141 | 0.0145 |
| Laminate thickness | millimeters | 0.37 | 0.39 | 0.35 | 0.34 | 0.36 | 0.37 |
| Dk @ 10 GHz | | 2.97 | 2.95 | 3.04 | 3.05 | 3.05 | 3.10 |
| Df @ 10 GHz | | 0.0009 | 0.0009 | 0.0009 | 0.0009 | 0.0009 | 0.0009 |
| Storage Mod., 23° C. | MPa | 2.75 | 2.34 | 1.95 | 3.12 | | |
| Initial Viscosity | P | 9.8 × 10⁷ | 9.6 × 10⁷ | 9.1 × 10⁷ | 8.5 × 10⁷ | 9.2 × 10⁷ | 8.1 × 10⁷ |
| Min. Viscosity | P | 2.5 × 10⁶ | 1.4 × 10⁷ | 1.4 × 10⁷ | 6.1 × 10⁶ | 1.5 × 10⁷ | 7.3 × 10⁶ |
| Final Viscosity | P | 1.0 × 10⁷ | 1.5 × 10⁷ | 1.4 × 10⁷ | 2.9 × 10⁷ | 2.8 × 10⁷ | 3.1 × 10⁷ |
| CTE, −40-140° C. | ppm/° C. | 45 | 32 | 36 | 38 | 31 | 36 |
| CTE, 50-150° C. | ppm/° C. | 53 | 39 | 42 | 43 | 33 | 39 |
| CTE, 150-250° C. | ppm/° C. | 40 | 43 | 28 | 45 | 34 | 45 |
| CTE, −55-288° C. | ppm/° C. | 50 | 42 | 39 | 44 | 35 | 42 |
| Tg peaks | ° C. | −14/103/224 | −8/92/293 | −13/93/>300 | 84/>300 | | |
| Specific Gravity | | 1.70 | 1.70 | 1.69 | 1.68 | 1.70 | 1.69 |
| Bond, Copper foil | pli | 3.67 | 3.71 | 3.85 | 3.28 | 3.51 | 3.37 |
| Bond, Copper foil | N/m | 643 | 650 | 674 | 574 | 614 | 590 |
| Bond, Copper foil, 10 | pli | 3.50 | 3.52 | 3.65 | 3.21 | | |
| days, 140° C. | | | | | | | |
| Bond, Copper foil, 10 | N/m | 613 | 616 | 639 | 562 | | |
| days, 140° C. | | | | | | | |
| Solder Float | | Pass | Pass | Pass | Pass | Pass | Pass |
| H₂O Absorption | % | 0.095 | 0.054 | 0.037 | 0.072 | 0.058 | 0.065 |
| UL Flame rating | | Fail | V-0 | V-0 | V-0 | | |

¹phr is parts per hundred based on 100 parts of SBC, HTP, PBD-2, and PBD-3

TABLE 2b

| | Units | E7 | E8 | E9 | E10 | E11 | E12 | E13 |
|---|---|---|---|---|---|---|---|---|
| Component | | | | | | | | |
| SBC | dry wt % | 14.8 | 14.8 | 12.9 | 12.9 | 14.8 | 14.8 | 17.4 |
| HTP | dry wt % | 2.8 | 1.9 | 4.6 | 3.7 | 2.8 | 1.9 | 3.3 |
| PBD-1 | dry wt % | | | 0.9 | 1.8 | 0.9 | 1.9 | 1.1 |
| PBD-2 | dry wt % | 0.9 | 1.9 | | | | | |
| Silica-1 | dry wt % | 73 | 73 | 73 | 73 | 73 | 73 | |
| Silica-2 | dry wt % | 0.4 | 0.4 | 0.4 | 0.4 | 0.4 | 0.4 | 2.0 |
| Silica-3 | dry wt % | | | | | | | 67.7 |
| Silane-1 | dry wt % | 0.5 | 0.5 | 0.5 | 0.5 | 0.5 | 0.5 | 0.5 |
| FR-1 | phr¹ | 35 | 35 | 35 | 35 | 35 | 35 | 35 |
| Peroxide-1 | phr¹ | 1 | 1 | 1 | 1 | 1 | 1 | 1 |
| Antioxidant-1 | phr¹ | 1 | 1 | 1 | 1 | 1 | 1 | 1 |
| Properties | | | | | | | | |
| Laminate thickness | inches | 0.0149 | 0.0132 | 0.0142 | 0.0132 | 0.0147 | 0.0138 | 0.021 |
| Laminate thickness | millimeters | 0.38 | 0.34 | 0.36 | 0.34 | 0.37 | 0.35 | 0.53 |
| Dk @ 10 GHz | | 3.05 | 3.10 | 3.05 | 3.06 | 3.09 | 3.09 | 2.969 |
| Df @ 10 GHz | | 0.0008 | 0.0008 | 0.0009 | 0.0009 | 0.0008 | 0.0008 | 0.0007 |
| Storage Mod., 23° C. | MPa | | | | | 2.6 | 2.24 | 2.23 |
| Initial Viscosity | P | 8.3 × 10⁷ | 7.7 × 10⁷ | 8.5 × 10⁷ | 8.5 × 10⁷ | 8.3 × 10⁷ | 7.7 × 10⁷ | 7.1E+07 |
| Min. Viscosity | P | 6.3 × 10⁶ | 3.2 × 10⁶ | 1.1 × 10⁷ | 6.4 × 10⁶ | 6.8 × 10⁶ | 3.5 × 10⁶ | 8.7E+06 |
| Final Viscosity | P | 1.6 × 10⁷ | 1.8 × 10⁷ | 2.5 × 10⁷ | 2.2 × 10⁷ | 1.5 × 10⁷ | 1.5 × 10⁷ | 1.5E+07 |
| CTE, −40-140° C. | ppm/° C. | 41 | 45 | 29 | 37 | 41 | 51 | 20 |
| CTE, 50-150° C. | ppm/° C. | 48 | 50 | 34 | 40 | 47 | 60 | 11 |
| CTE, 150-250° C. | ppm/° C. | 33 | 52 | 48 | 47 | 49 | 59 | 34 |
| CTE, −55-288° C. | ppm/° C. | 42 | 50 | 39 | 43 | 48 | 58 | −18/88/294 |
| Tg peaks | ° C. | | | | | −12/94/>300 | −6/82/>300 | 1.64 |
| Specific Gravity | | 1.69 | 1.70 | 1.68 | 1.67 | 1.70 | 1.71 | 4.46 |
| Bond, Copper foil | pli | 4.25 | 4.01 | 3.86 | 3.60 | 4.33 | 3.99 | 4.26 |
| Bond, Copper foil | N/m | 744 | 702 | 676 | 630 | 758 | 699 | 746 |
| Bond, Copper foil, 10 | pli | | | | | | | 3.98 |
| days, 140° C. | | | | | | | | |
| Bond, Copper foil, 10 | N/m | | | | | | | 697 |
| days, 140° C. | | | | | | | | |
| Solder Float | | Pass | Pass | Pass | Pass | Pass | Pass | Pass |
| H₂O Absorption | % | 0.053 | 0.032 | 0.042 | 0.056 | 0.079 | 0.058 | 0.021 |
| UL Flame rating | | | | | | | | V-0 |

¹phr is parts per hundred based on 100 parts of SBC, HTP, PBD-1, and PBD-2

TABLE 2c

| | Units | E14 | E15 | E16 | E17 | E18 | E19 |
|---|---|---|---|---|---|---|---|
| Component | | | | | | | |
| SBC | dry wt % | 15.4 | 14.9 | 14.5 | 15.9 | 15.4 | 15.0 |
| HTP | dry wt % | 4.1 | 4.0 | 3.8 | 4.2 | 4.1 | 4.0 |
| PBD-1 | dry wt % | 1.0 | 1.0 | 1.0 | 1.1 | 1.0 | 1.0 |
| Silica-3 | dry wt % | 69.6 | 70.4 | 71.2 | 68.0 | 68.9 | 69.7 |
| Filler | dry wt % | 0.5 | 0.5 | 0.5 | 1.1 | 1.1 | 1.1 |
| Silane-1 | dry wt % | 0.5 | 0.5 | 0.5 | 0.5 | 0.5 | 0.5 |
| FR-1 | phr¹ | 41.3 | 41.3 | 41.3 | 41.3 | 41.3 | 41.3 |
| Initiator | phr¹ | 1.1 | 1.1 | 1.1 | 1.1 | 1.1 | 1.1 |
| Antioxidant-1 | phr¹ | 1.1 | 1.1 | 1.1 | 1.1 | 1.1 | 1.1 |
| Properties | | | | | | | |
| SPDR Laminate thickness | inches | 0.0053 | 0.0052 | 0.0052 | 0.0050 | 0.0059 | 0.0061 |
| SPDR Laminate thickness | millimeters | 0.13 | 0.13 | 0.13 | 0.13 | 0.15 | 0.15 |
| SPDR Dk @ 10 GHz | | 3.02 | 2.99 | 2.96 | 3.05 | 2.98 | 2.97 |
| SPDR Df @ 10 GHz | | 0.0007 | 0.0007 | 0.0007 | 0.0008 | 0.0008 | 0.0008 |
| Stripline Laminate thickness | inches | 0.022 | 0.021 | 0.021 | 0.020 | 0.023 | 0.024 |
| Stripline Laminate thickness | millimeters | 0.56 | 0.53 | 0.53 | 0.51 | 0.58 | 0.6 |
| Stripline Dk @ 10 GHz | | 3.05 | 3.01 | 3.00 | 3.04 | 3.00 | 2.99 |
| Stripline Df @ 10 GHz | | 0.0007 | 0.0008 | 0.0015 | 0.0014 | 0.0009 | 0.0008 |
| Specific Gravity (ATD puck) | | 1.73 | 1.73 | 1.74 | 1.71 | 1.70 | 1.70 |
| Storage Mod., 23° C. | GPa | 2.36 | | | | | |
| Initial Viscosity | P | 8.5E+07 | 9.1E+07 | 8.7E+07 | 8.8E+07 | 7.9E+07 | 8.8E+07 |
| Min. Viscosity | P | 3.8E+06 | 5.7E+06 | 1.8E+07 | 3.1E+06 | 4.0E+06 | 6.7E+06 |
| Final Viscosity | P | 2.1E+07 | 2.5E+07 | 3.4E+07 | 1.7E+07 | 2.0E+07 | 2.3E+07 |
| CTE, −40-140° C. (Z direction) | ppm/° C. | 36 | 31 | 23 | 45 | 39 | 29 |
| CTE, 50-150° C. (Z direction) | ppm/° C. | 41 | 31 | 17 | 59 | 47 | 27 |
| CTE, 150-250° C. (Z direction) | ppm/° C. | 64 | 60 | 49 | 83 | 72 | 65 |
| CTE, −55-288° C. (Z direction) | ppm/° C. | 48 | 42 | 32 | 63 | 54 | 43 |
| CTE, −40-140° C. (XY direction) | ppm/° C. | 32 | 31 | 26 | 33 | 33 | 25 |
| CTE, 50-150° C. (XY direction) | ppm/° C. | 25 | 26 | 19 | 26 | 29 | 14 |
| CTE, 150-250° C. (XY direction) | ppm/° C. | 66 | 78 | 62 | 71 | 66 | 70 |
| CTE, −55-288° C. (XY direction) | ppm/° C. | 42 | 43 | 34 | 43 | 44 | 35 |
| DMA peaks | ° C. | −20/90/200/275 | | | | | |
| Bond, Copper foil | pli | 3.7 | 3.5 | No Data | 3.4 | 3.5 | 3.3 |
| Bond, Copper foil | N/m | 648 | 613 | — | 595 | 613 | 578 |

¹phr is parts per hundred based on 100 parts of SBC, HTP, and PBD-1

TABLE 2d

| | Units | E20 | E21 | E23 | E24 | E25 | E26 |
|---|---|---|---|---|---|---|---|
| Component | | | | | | | |
| SBC | dry wt % | 15.7 | 15.7 | 14.6 | 15.2 | 15.4 | 15.7 |
| HTP | dry wt % | 4.2 | 3.1 | 4.2 | 4.0 | 4.1 | 4.2 |
| CC | dry wt % | 1.1 | 2.1 | 2.1 | 1.0 | 1.0 | 1.1 |
| Silica-3 | dry wt % | 69.0 | 68.9 | 69.0 | 69.9 | 69.3 | 68.3 |
| Filler | dry wt % | 0.5 | 0.5 | 0.5 | 0.5 | 0.8 | 1.1 |
| Silane-1 | dry wt % | 0.5 | 0.5 | 0.5 | 0.5 | 0.5 | 0.5 |
| FR-1 | phr¹ | 41.3 | 41.3 | 41.3 | 41.3 | 41.3 | 41.3 |
| Initiator | phr¹ | 1.1 | 1.1 | 1.1 | 1.1 | 1.1 | 1.1 |
| Antioxidant-1 | phr¹ | 1.1 | 1.1 | 1.1 | 1.1 | 1.1 | 1.1 |
| Properties | | | | | | | |
| SPDR Laminate thickness | inches | 0.0053 | 0.0052 | 0.0042 | 0.0048 | 0.0052 | 0.0050 |
| SPDR Laminate thickness | millimeters | 0.13 | 0.13 | 0.11 | 0.12 | 0.13 | 0.13 |
| SPDR Dk @ 10 GHz | | 3.08 | 3.09 | 3.05 | 3.03 | 3.03 | 3.02 |
| SPDR Df @ 10 GHz | | 0.0008 | 0.0008 | 0.0008 | 0.0008 | 0.0008 | 0.0008 |
| Stripline Laminate thickness | inches | 0.022 | 0.021 | 0.017 | 0.019 | 0.021 | 0.020 |
| Stripline Laminate thickness | millimeters | 0.56 | 0.53 | 0.43 | 0.48 | 0.53 | 0.51 |
| Stripline Dk @ 10 GHz | | 3.08 | 3.08 | 3.08 | 3.00 | 3.03 | 3.01 |
| Stripline Df @ 10 GHz | | 0.0007 | 0.0006 | 0.0020 | 0.0016 | 0.0010 | 0.0012 |
| Storage Mod., 23° C. | GPa | 2.23 | 2.51 | 2.67 | | | |
| Initial Viscosity | P | 9.5E+07 | 9.0E+07 | 9.6E+07 | 9.3E+07 | 7.0E+07 | 8.7E+07 |
| Min. Viscosity | P | 2.2E+06 | 1.0E+06 | 1.3E+06 | 3.9E+06 | 3.2E+06 | 2.4E+06 |
| Final Viscosity | P | 1.7E+07 | 2.1E+07 | 3.1E+07 | 2.1E+07 | 1.8E+07 | 1.7E+07 |
| CTE, −40-140° C. (Z direction) | ppm/° C. | 39 | 42 | 32 | 29 | 32 | 38 |
| CTE, 50-150° C. (Z direction) | ppm/° C. | 47 | 52 | 35 | 27 | 36 | 44 |
| CTE, 150-250° C. (Z direction) | ppm/° C. | 78 | 81 | 65 | 53 | 76 | 71 |
| CTE, −55-288° C. (Z direction) | ppm/° C. | 57 | 60 | 46 | 39 | 51 | 53 |
| CTE, −40-140° C. (XY direction) | ppm/° C. | 34 | 38 | 28 | 29 | 30 | 32 |
| CTE, 50-150° C. (XY direction) | ppm/° C. | 30 | 37 | 22 | 22 | 25 | 27 |
| CTE, 150-250° C. (XY direction) | ppm/° C. | 60 | 72 | 59 | 57 | 58 | 68 |
| CTE, −55-288° C. (XY direction) | ppm/° C. | 40 | 50 | 36 | 36 | 37 | 43 |
| DMA peaks | ° C. | −17/93/200/275 | −17/98/204 | −17/98/213 | | | |
| Bond, Copper foil | pli | 3.2 | 2.9 | 2.3 | 3.1 | 3.4 | 3.7 |
| Bond, Copper foil | N/m | 560 | 508 | 403 | 543 | 595 | 648 |

¹phr is parts per hundred based on 100 parts of SBC, HTP, and CC

As shown in Table 2a, Table 2b, Table 2c, and Table 2d, compositions were formulated and tested with varying amounts of SBC, HTP, CC, PBD-1, PBD-2, or PBD-3. The filler was a combination of solid and hollow silica particles at a weight ratio of 99.5:0.5 solid to hollow. The compositions advantageously exhibited a dielectric constant Dk around 3.0, and a loss of below 0.001. The CTE was also observed to be in a desirable range.

Examples 14-19, which included PBD-1, and Examples 20-26, which included CC, provided desirable results. CC demonstrated better long term high temperature storage stability (i.e., no change in electrical properties with 3,000 hours storage at 140° C.). PBD-1 may be less expensive than CC and a better option if cost is a concern, if the final product properties are not particularly demanding, or a combination thereof. Example 25 demonstrates an especially desirable balanced set of properties as well as the best curable product characteristics, such as, lay flat, no tack, no curl, etc.

This disclosure further encompasses the following aspects.

Aspect 1: A curable composition comprising: 1 to 25 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; 0.1 to 20 weight percent of a polymeric reactive diluent having a glass transition temperature of greater than or equal to 100° C. and at least one crosslinkable reactive group; and 50 to 90 weight percent of a filler; wherein weight percent of each component is based on a total weight of dry components of the curable composition.

Aspect 2: The curable composition of aspect 1, wherein: each A block of the hydrogenated block copolymer is derived from para-methylstyrene; each B block of the hydrogenated block copolymer is a copolymer derived from para-methylstyrene and a conjugated diene selected from the group consisting of isoprene, butadiene, or a combination thereof, wherein the B block has a conjugated diene content of 10 to 55%; wherein each A block has a peak molecular weight of 3 to 60 kg/mol and each B block has a peak molecular weight of 20 to 200 kg/mol.

Aspect 3: The curable composition of aspect 1 or 2, wherein the polymeric reactive diluent has a glass transition temperature of 100 to 300° C.

Aspect 4: The curable composition of any of aspects 1 to 3, further comprising 0.1 to 10 weight percent of a polybutadiene, preferably a polybutadiene having at least 80% 1,2-vinyl content, based on the total weight of dry components of the polybutadiene.

Aspect 5: The curable composition of aspect claim 4, comprising: 14.9 to 15.9 weight percent of the hydrogenated block copolymer; 3.8 to 4.2 weight percent the polymeric reactive diluent; 1 to 1.1 weight percent of the polybutadiene; and 69.1 to 71.7 weight percent of a filler, wherein weight percent of each component is based on the total weight of dry components of the curable composition.

Aspect 6: The curable composition of any of aspects 1 to 5, wherein the filler comprises silica.

Aspect 7: The curable composition of any of aspects 1 to 6, wherein the filler comprises a mixture of solid silica particles and hollow silica particles.

Aspect 8: The curable composition of any of aspects 1 to 7, further comprising an initiator, preferably a peroxide initiator, more preferably dicumyl peroxide, 2,5-dimethyl-2,5-di(t-butylperoxy)hexane, α,α′-di(t-butylperoxy)diisopropylbenzene, 2,5-dimethyl-2,5-di(t-butylperoxy)hexyne, or 3,1,1-di(t-butylperoxy)-3,5,5-trimethylcyclohexane.

Aspect 9: The curable composition of any of aspects 1 to 8, further comprising a flame retardant, preferably 1 to 20 weight percent of the flame retardant, based on the total weight of dry components of the curable composition.

Aspect 10: The curable composition of any of aspects 1 to 9, further comprising an additive composition, preferably wherein the additive composition comprises an antioxidant and a silane.

Aspect 11: The curable composition of aspect 1, further comprising: 0.1 to 10 weight percent of a polyaromatic vinyl compound, based on the total weight of dry components of the curable composition.

Aspect 12: The curable composition of aspect 11, comprising: 14.6 to 15.7 weight percent of the hydrogenated block copolymer; 3.1 to 4.2 weight percent the polymeric reactive diluent; 1 to 2.1 weight percent of the polyaromatic vinyl compound; and 69.4 to 70.4 weight percent of a filler, wherein weight percent of each component is based on the total weight of dry components of the curable composition.

Aspect 13: The curable composition of aspect 11 or 12, wherein the polyaromatic vinyl compound is represented by formula (1):

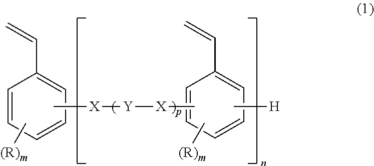

wherein
   X and Y each represent an organic group, wherein each X is the same as or different from each other, and wherein each Y is the same as or different from each other,
   R is a hydrocarbon group having 1 to 10 carbon atoms or a halogenated alkyl group, wherein each R is the same as or different from each other,
   m is an integer of 0 to 3,
   1≤n≤20, and
   0≤p≤20.

Aspect 14: The curable composition of aspect 11 or 12, wherein the polyaromatic vinyl compound is represented by formula (4)

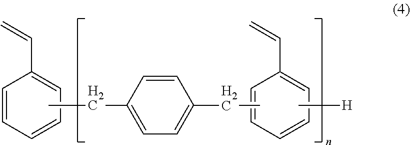

wherein 1≤n≤20.

Aspect 15: A varnish comprising the curable composition of any of aspects 1 to 14 and a solvent.

Aspect 16: A cured composition obtained from the curable composition of any of aspects 1 to 14 or the varnish of aspect 15.

Aspect 17: The cured composition of aspect 16, wherein the cured composition exhibits one or more of: a dissipation factor (Df) of 0.0006 to 0.005, or 0.001 to 0.003, or 0.001 to 0.0025, or 0.001 to 0.002, at 10 GHz; a dielectric constant (Dk) of 2.9 to 3.4 at 10 GHz; a coefficient of thermal expansion of less than or equal to 130 ppm/° C., or 5 to 130 ppm/° C., or 5 to 55 ppm/° C., or 5 to 25 ppm/° C., measured with thermomechanical analysis over a temperature range of −55 to 288° C.; a peel strength from copper of 0.5 to 5.5 lb/in (88 to 963 N/m), or 1 to 5 lb/in (175 to 876 N/m); and a UL94 flammability rating of V-0.

Aspect 18: The cured composition of aspect 16 or 17, wherein the cured composition is in the form of a film.

Aspect 19: The cured composition of aspect 18, wherein the film has a thickness of 10 to 100 micrometers.

Aspect 20: A composite laminate comprising the cured composition of aspects 16 or 17.

Aspect 21: The composite laminate of aspect 20, wherein the cured composition is in contact with a reinforcing layer, preferably a glass fiber reinforcing layer.

Aspect 22: The composite laminate of aspect 20, wherein the cured composition is not in contact with a reinforcing layer, for example, a glass fiber reinforcing layer.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ Cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A curable composition comprising:
1 to 25 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound;
0.1 to 20 weight percent of a polymeric reactive diluent having a glass transition temperature of greater than or equal to 100° C. and at least one crosslinkable reactive group; and
50 to 90 weight percent of a filler;
wherein weight percent of each component is based on a total weight of dry components of the curable composition.

2. The curable composition of claim 1, wherein:
each A block of the hydrogenated block copolymer is derived from para-methylstyrene;
each B block of the hydrogenated block copolymer is a copolymer derived from para-methylstyrene and a conjugated diene selected from the group consisting of isoprene, butadiene, or a combination thereof, wherein the B block has a conjugated diene content of 10 to 55%;
wherein each A block has a peak molecular weight of 3 to 60 kg/mol and each B block has a peak molecular weight of 20 to 200 kg/mol.

3. The curable composition of claim 1, wherein the polymeric reactive diluent has a glass transition temperature of 100 to 300° C.

4. The curable composition of claim 1, further comprising:
0.1 to 10 weight percent of a polybutadiene.

5. The curable composition of claim 4, comprising:
14.9 to 15.9 weight percent of the hydrogenated block copolymer;
3.8 to 4.2 weight percent the polymeric reactive diluent;
1 to 1.1 weight percent of the polybutadiene; and
69.1 to 71.7 weight percent of a filler,
wherein weight percent of each component is based on the total weight of dry components of the curable composition.

6. The curable composition of claim 1, wherein the filler comprises silica.

7. The curable composition of claim 1, wherein the filler comprises a mixture of solid silica particles and hollow silica particles.

8. The curable composition of claim 1, further comprising an initiator.

9. The curable composition of claim 1, further comprising a flame retardant.

10. The curable composition of claim 1, further comprising an additive composition.

11. The curable composition of claim 1, further comprising:
0.1 to 10 weight percent of a polyaromatic vinyl compound, based on the total weight of dry components of the curable composition.

12. The curable composition of claim 11, comprising:
14.6 to 15.7 weight percent of the hydrogenated block copolymer;
3.1 to 4.2 weight percent the polymeric reactive diluent;
1 to 2.1 weight percent of the polyaromatic vinyl compound; and
69.4 to 70.4 weight percent of a filler,
wherein weight percent of each component is based on the total weight of dry components of the curable composition.

13. The curable composition of claim 11, wherein the polyaromatic vinyl compound is represented by formula (1): 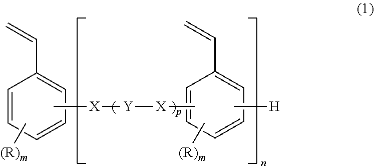
wherein
X and Y each represent an organic group, wherein each X is the same as or different from each other, and wherein each Y is the same as or different from each other,
R is a hydrocarbon group having 1 to 10 carbon atoms or a halogenated alkyl group, wherein each R is the same as or different from each other,
m is an integer of 0 to 3,
1≤n≤20, and
0≤p≤20.

14. The curable composition of claim 11, wherein the polyaromatic vinyl compound is represented by formula (4) 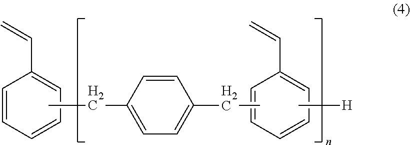
wherein 1≤n≤20.

15. A cured composition obtained from the curable composition of claim 1.
